(19) United States
(12) Patent Application Publication
(10) Pub. No.: US 2026/0118875 A1
(43) Pub. Date: Apr. 30, 2026

(54) SELF-POSITION ESTIMATION SYSTEM

(71) Applicant: Panasonic Intellectual Property Management Co., Ltd., Osaka (JP)

(72) Inventors: AKIO SHIGEKANE, Kanagawa (JP); SHINGO MORIMOTO, Aichi (JP)

(21) Appl. No.: 19/044,041

(22) Filed: Feb. 3, 2025

Related U.S. Application Data
(63) Continuation of application No. PCT/JP2023/026311, filed on Jul. 18, 2023.

(30) Foreign Application Priority Data
Aug. 9, 2022 (JP) 2022-127015

(51) Int. Cl. G05D 1/246; G05D 1/248; G05D 109/10; G05D 111/10; G05D 111/50

(52) U.S. Cl. CPC G05D 1/246; G05D 1/248; G05D 2109/10; G05D 2111/17; G05D 2111/54

(57) ABSTRACT

A self-position estimation system for a mobile body, includes: a first self-position estimation unit that estimates a first self-position in a first coordinate system by using a first positioning sensor mounted on the mobile body; a second self-position estimation unit that estimates a second self-position in a second coordinate system by using a second positioning sensor mounted on the mobile body; a self-position convert unit that converts the first self-position estimated by the first self-position estimation unit and expressed in the first coordinate system into an expression format in the second coordinate system; and a self-position correction unit that corrects the first self-position converted into an expression format in the second coordinate system using correction information map data that stores, as correction information, a positional deviation amount of a recording point in a real space expressed in the first coordinate system with respect to the second coordinate system.

### TECHNICAL FIELD

The present disclosure relates to a self-position estimation system.

### BACKGROUND ART

As an effort to save labor, expectations for autonomous mobile robots are increasing.

In autonomous movement, the robot needs to know where it is at all times, and this is achieved by various self-position estimation algorithms.

In conventional indoor autonomous movement, self-position estimation by Lidar and a grid map is generally used. In the outdoors, for example, in automatic operation for large-scale agriculture or the like, the traveling area is large, but the sky is open over the entire traveling area, and radio waves from the satellite are easily received, so that position estimation by the GNSS is easily performed at a relatively low cost. On the other hand, even in the outdoors, for example, in the last one mile delivery or the like, the traveling area is centered on a residential area, a building area, or the like, and the sky is not always open, and an area where the GNSS cannot be used is included in the traveling area.

In view of these, in general, for more flexible traveling of an autonomous mobile robot, processing of complementarily using a plurality of self-position estimation means is performed. For example, Patent Literature 1 describes a method of positioning measurement results of a plurality of measurement units using coordinate transformation, and then performing self-position estimation and shape measurement of a mobile body.

### CITATION LIST

### Patent Literature

PTL 1: Unexamined Japanese Patent Publication No. 2017-150977

### SUMMARY OF THE INVENTION

However, in the related art such as Patent Literature 1, there is a problem that a deviation occurs between two estimated self-positions derived by different self-position estimation algorithms due to distortion of the coordinate system, and the self-position becomes unstable. For example, since self-position estimation on the grid map is relative self-positioning with reference to the grid map, distortion of the coordinate system is likely to occur unlike the GNSS in which absolute coordinates are always acquired.

In a case where a process of performing positioning between two estimated self-positions derived by different self-position estimation algorithms is attempted in a state in which the distortion of the coordinate system is included in this manner, a large discrepancy occurs between the two estimated self-positions, and when the robot switches the self-position estimation algorithm, there is a possibility that the self-position is lost or misread.

The present invention has been made in view of the above problems, and an object of the present invention is to provide a self-position estimation system capable of suppressing positional displacement of a self-position estimated by two self-position estimation algorithms when the two self-position estimation algorithms are complementarily used.

A main aspect of the present invention for solving the above-described problems is a self-position estimation system for a mobile body, including: a first self-position estimation unit that estimates a first self-position in a first coordinate system by using a first positioning sensor mounted on the mobile body; a second self-position estimation unit that estimates a second self-position in a second coordinate system by using a second positioning sensor mounted on the mobile body; a self-position convert unit that converts the first self-position estimated by the first self-position estimation unit and expressed in the first coordinate system into an expression format in the second coordinate system; and a self-position correction unit that corrects the first self-position converted into an expression format in the second coordinate system using correction information map data that stores, as correction information, a positional deviation amount of a recording point in a real space expressed in the first coordinate system with respect to the second coordinate system.

According to the position estimation system of the present disclosure, it is possible to suppress the positional deviation of the self-position estimated by two self-position estimation algorithms when both the self-position estimation algorithms are complementarily used.

### BRIEF DESCRIPTION OF THE DRAWINGS

FIG. 1 is a diagram for explaining a definition of a self-position.

FIG. 2 is a diagram illustrating a configuration of an autonomous mobile robot including a self-position estimation system according to an exemplary embodiment of the present invention.

FIG. 3 is a diagram illustrating functional blocks of the self-position estimation system of the autonomous mobile robot according to the exemplary embodiment of the present invention.

FIG. 4 is a diagram for explaining a definition of a position derived by a first self-position estimation unit.

FIG. 5 is a diagram for explaining a definition of a position derived by a second self-position estimation unit.

FIG. 6 is a diagram for explaining conversion of a coordinate system performed by a self-position convert unit.

FIG. 7 is a flowchart illustrating correction processing performed by a self-position correction unit.

FIG. 8 is a flowchart of a subroutine obtained by decomposing processing of S530 in FIG. 7 into detailed steps.

FIG. 9 is a view schematically illustrating processing of S530 in FIG. 7.

### DESCRIPTION OF EMBODIMENT

An exemplary embodiment of the present invention will be described below with reference to drawings.

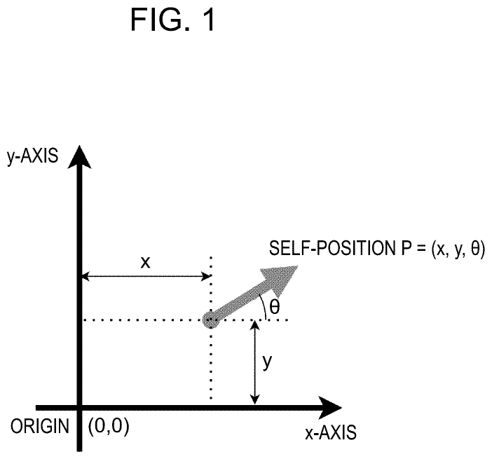

First, the definition of the self-position will be described with reference to FIG. 1.

The self-position refers to a scalar value of an angle (that is, an attitude) of the robot and coordinates of the robot. The coordinate is a value obtained by integrating the X coordinate and the Y coordinate on the plane on which the robot moves. That is, the self-position is defined as the following Formula (1). Note that, hereinafter, for convenience of description, both concepts of the “position” and the “attitude (that is, the direction)” of the robot (mobile body) are collectively referred to as “position”.

$$\begin{matrix}[ Math . 1 ] & \\ Self - position P = ( x , y , θ ) & ( 1 )\end{matrix}$$

Next, an autonomous mobile robot will be described.

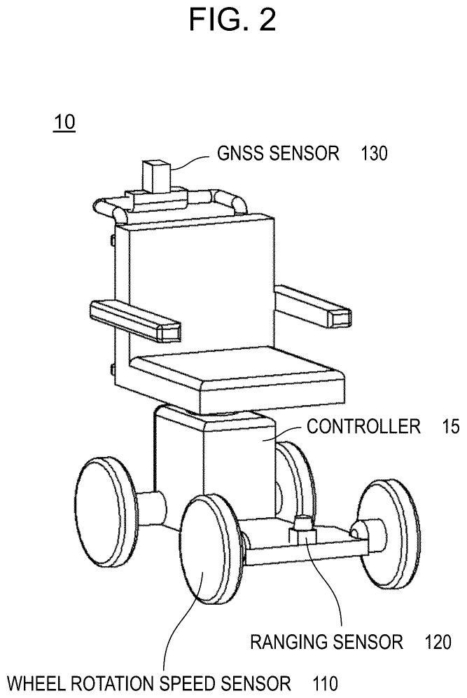

FIG. 2 is a diagram showing a configuration of autonomous mobile robot 10 including a self-position estimation system according to an exemplary embodiment of the present invention. Autonomous mobile robot 10 (corresponding to a “mobile body” of the present invention) performs autonomous movement while estimating a self-position.

Autonomous mobile robot 10 is equipped with wheel rotation speed sensor 110, ranging sensor 120, GNSS sensor 130 sensor, and controller 15.

Wheel rotation speed sensor 110 is a sensor that measures the rotation speed of each of the left and right wheels. The movement amount of autonomous mobile robot 10 from the reference position can be calculated based on the temporal change in the vehicle speed and the yaw rate estimated from wheel rotation speed sensor 110, and the current position of autonomous mobile robot 10 can be estimated based on the movement amount.

Ranging sensor 120 is a two-dimensional scanning type optical distance sensor that measures a distance to a detection object in the outside world while scanning laser light, and is, for example, a light detection and ranging (LIDAR). The data obtained from ranging sensor 120 is obtained by acquiring distance information to an obstacle or a wall for each certain angular resolution.

GNSS sensor 130 calculates the position of a reception point using, for example, distance measurement signals from a plurality of GPS satellites. The data obtained from GNSS sensors 130 is latitude and longitude information of the sensor position. However, since GNSS sensor 130 measures the position using the radio waves transmitted from the GNSS artificial satellites, the estimation accuracy thereof changes depending on the arrangement of the artificial satellites at the time of measurement, the weather, the presence or absence of surrounding buildings, and the like.

Next, self-position estimation system U of autonomous mobile robot 10 will be described.

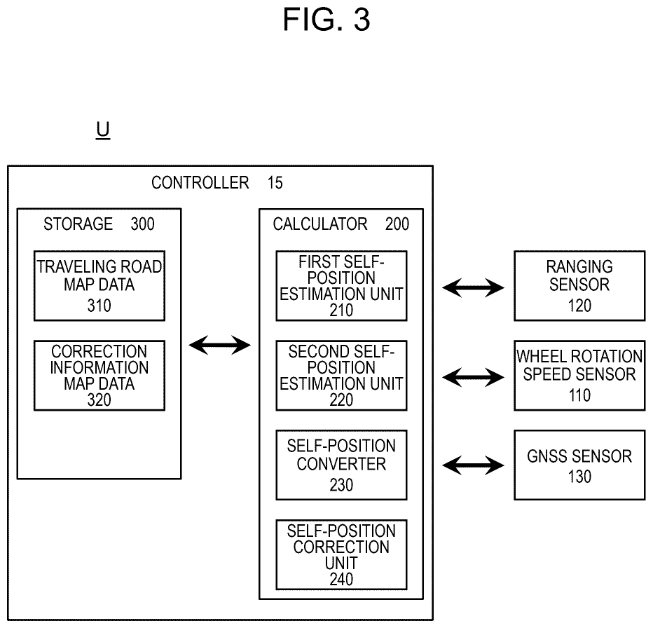

FIG. 3 is a diagram illustrating functional blocks of self-position estimation system U of autonomous mobile robot 10.

Controller 15 estimates the self-position of autonomous mobile robot 10. At this time, the self-position estimation in the present patent is roughly divided into the following two types of processing.
(1) Processing of self-position estimation of each of first self-position estimation unit 210 and second self-position estimation unit 220 (described later)
(2) Processing of correcting the self-position estimated by first self-position estimation unit 210 using correction information map data 320

Controller 15 is, for example, a so-called computer including a CPU, a memory, and the like. Controller 15 has functional blocks called calculator 200 and storage 300. Controller 15 is connected to wheel rotation speed sensor 110, ranging sensor 120, and GNSS sensor 130 in a wired or wireless manner.

Storage 300 includes traveling road map data 310 and correction information map data 320. Storage 300 is a non-volatile storage device such as an HDD mounted on a so-called PC.

Traveling road map data 310 uses what is called an occupancy grid map, and is data in bitmap format in which a region where the robot can move is represented in white, and a place (that is, a region where the robot cannot move) where a fixed object such as a wall or a signboard is present is represented in black. Note that traveling road map data 310 is created using, for example, simultaneous localization and mapping (SLAM) processing for sequentially performing self-position estimation and map creation using ranging sensor 120.

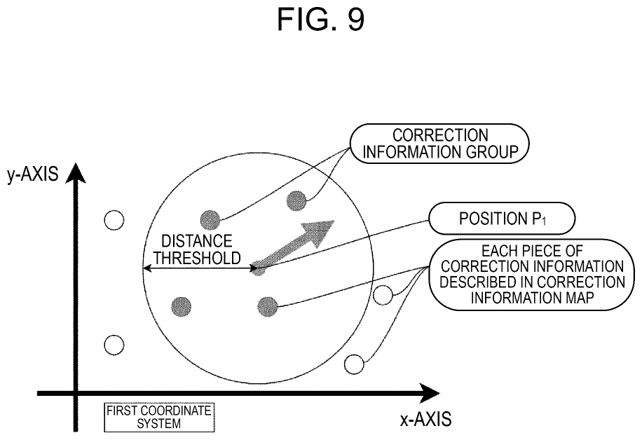

Correction information map data 320 is data in which correction information ancor of respective positions (that is, each recording point where the correction information is actually measured) in the real space are arranged so as to cover a region where the robot can move in the first coordinate system used by first self-position estimation unit 210 (see FIG. 9).

The correction information is correction data for accurately converting the position and attitude on the first coordinate system estimated by first self-position estimation unit 210 into the position and attitude of the second coordinate system used by second self-position estimation unit 220. The correction information is, for example, data in which a position on the first coordinate system is associated with correction amounts related to the x direction, the y direction, and the rotation direction at the position as in the following Formula (2). As the correction information, information on coordinate distortion obtained in advance by actual measurement at each recording point in the real space is used (detail description is given later).

Formula (2) indicates correction information set at a certain point in the first coordinate system, and the correction information is set separately for each position in the region where the robot in the first coordinate system can move.

$$\begin{matrix}[ Math . 2 ] & \\ ancor = {x}_{acnpose} , {y}_{acnpose} , {x}_{anchosei} , {y}_{anchosei} , {θ}_{anchosei} & ( 2 )\end{matrix}$$

Here, x_{acnpose} and y_{acnpose} are positions in the first coordinate system in which the correction information is set.
In addition, x_{anchosei}, y_{anchosei}, and θ_{anchosei} are correction amounts in the x direction, the y direction, and the rotation direction included in the correction information.

Calculator 200 includes first self-position estimation unit 210, second self-position estimation unit 220, self-position convert unit 230, and self-position correction unit 240.

First self-position estimation unit 210 estimates the self-position of autonomous mobile robot 10 using the value of ranging sensor 120 and traveling road map data 310 included in storage 300. Hereinafter, the self-position of autonomous mobile robot 10 estimated by first self-position estimation unit 210 is referred to as a “position P₁” or a “first self-position P₁”.

In the first self-position estimation method performed by first self-position estimation unit 210, for example, position estimation is performed by performing so-called scan matching processing using the measurement value of wheel rotation speed sensor 110, the measurement value of ranging sensor 120, and traveling road map data 310.

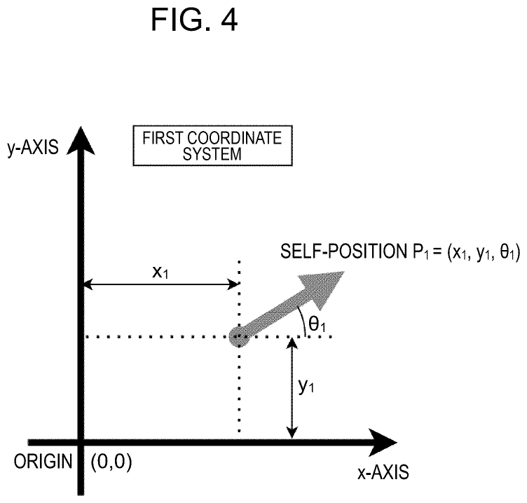

The definition of position P₁ derived by first self-position estimation unit 210 will be described with reference to FIG. 4. Position P₁ has, for example, a data format of the following Formula (3) as shown in the following formula.

$$\begin{matrix}[ Math . 3 ] & \\ {P}_{\{ 1 \}} = ( {x}_{\{ 1 \}} , {y}_{\{ 1 \}} , {θ}_{\{ 1 \}} ) & ( 3 )\end{matrix}$$

Note that each element on the right side of Formula (3) is a scalar value, and the angle is an angle value in which (x, y)=(1, 0) vector direction with the Z axis as the center is an angle value of 0. The coordinate system is a first coordinate system.

Second self-position estimation unit 220 estimates the self-position of autonomous mobile robot 10 using GNSS sensor 130 and wheel rotation speed sensor 110. The self-position of autonomous mobile robot 10 estimated by second self-position estimation unit 220 is referred to as a “position P₂” or a “second self-position P₂”.

In the second self-position estimation method performed by second self-position estimation unit 220, position estimation is performed by time development of a state space model using a so-called Kalman filter or the like using a measurement value of wheel rotation speed sensor 110 and a measurement value of GNSS sensor 130.

The second self-position estimation method will be described in more detail. First, second self-position estimation unit 220 calculates coordinate points on a plane using a geodetic system such as WGS84 by using the values of latitude and longitude measured by GNSS sensor 130. Next, second self-position estimation unit 220 calculates the sequential movement amount using the value of the wheel rotation speed measured by wheel rotation speed sensor 110. Then, second self-position estimation unit 220 integrates the coordinate points on the plane and the sequential movement amount using a method such as a Kalman filter, and outputs position P₂ as a self-position estimation result.

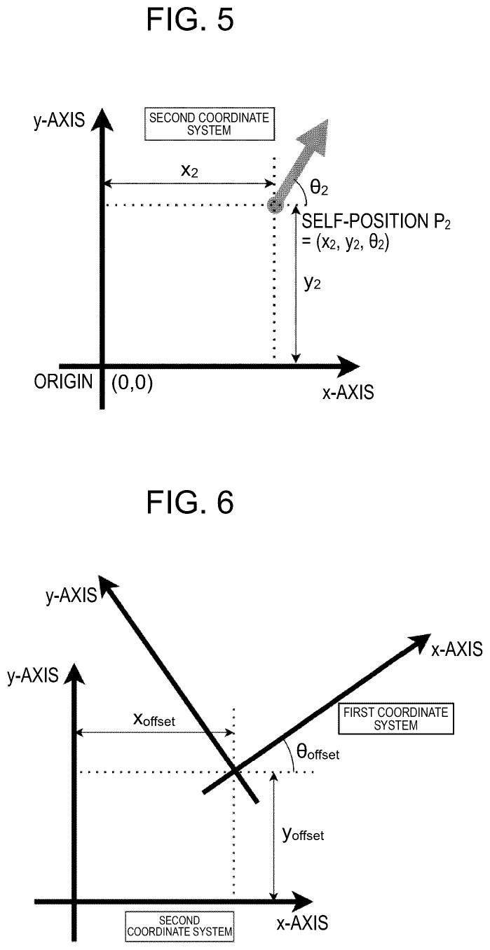

The definition of position P₂ estimated by second self-position estimation unit 220 will be described with reference to FIG. 5. Position P₂ has a data format of the following Formula (4).

$$\begin{matrix}[ Math . 4 ] & \\ P\_ \{ 2 \} = ( x\_ \{ 2 \} , y\_ \{ 2 \} , θ\_ \{ 2 \} ) & ( 4 )\end{matrix}$$

Note that each element on the right side of Formula (4) is a scalar value, and the angle is an angle value in which (x, y)=(1, 0) vector direction with the Z axis as the center is an angle value of 0. Position P₂ is expressed in a second coordinate system.

Self-position convert unit 230 converts the self-position estimation result in the first coordinate system output from first self-position estimation unit 210 into a self-position estimation value in the second coordinate system.

Here, the transformation of the coordinate system performed by self-position convert unit 230 will be described with reference to FIG. 6.

The positional relationship of the origin of the positional relationship between the first coordinate system and the second coordinate system is defined by rotation and translation. Therefore, coordinate transformation vector P_{offset} for coordinate-transforming position P₁ expressed in the first coordinate system into the second coordinate system is defined by rotation and translation. In the case of the positional relationship illustrated in FIG. 6, the coordinate transformation vector is expressed by the following Formula (5).

$$\begin{matrix}[ Math . 5 ] & \\ P\_ \{ offset \} = ( x\_ \{ offset \} , y\_ \{ offset \} , θ\_ \{ offset \} ) & ( 5 )\end{matrix}$$

By using P_{offset}, the self-position estimation result estimated in the first coordinate system can be coordinate-transformed into the second coordinate system. That is, position P₁ is coordinate-transformed into the second coordinate system. The coordinate-transformed attitude of position P₁ is referred to as position P_{transed}. The data of position P_{transed} is expressed as, for example, the following Formula (6).

$$\begin{matrix}[ Math . 6 ] & \\ \begin{matrix}{P}_{transed} = ( {x}_{transed} , {y}_{transed} , {θ}_{transed} ) \\ {x}_{transed} = {x}_{offset} + \sqrt{{x}_{1}^{2} + {y}_{1}^{2}} cos ( {θ}_{1 +} {θ}_{offset} ) \\ {y}_{transed} = {y}_{offset} + \sqrt{{x}_{1}^{2} + {y}_{1}^{2}} cos ( {θ}_{1 +} {θ}_{offset} ) \\ {θ}_{transed} = {θ}_{1} + {θ}_{offset}\end{matrix} & ( 6 )\end{matrix}$$

Note that the x coordinate position and the y coordinate position on the right side of Formula (6) are scalar values, and the angle θ is an angle value in which (x, y)=(1, 0) vector direction with the Z axis as the center is an angle value of 0. Here, the x coordinate position, the y coordinate position, and the angle θ are values expressed in the second coordinate system.

Here, if the first self-position estimation method and the second self-position estimation method produce ideal estimation results, position P₂ and position P_{transed} measured when autonomous mobile robot 10 is present at a certain point are the same.

However, in a case where distortion exists in the estimation result for each location in the first coordinate system, an error occurs depending on where autonomous mobile robot 10 exists in the traveling area. Therefore, due to the distortion, there is a possibility that position P₁ measured in the first coordinate system and a position coordinate-transformed into the second coordinate system does not coincide with position P₂ measured in the second coordinate system. As a result, for example, when the robot switches the self-position estimation algorithm, it is conceivable that the robot loses sight of or misses the self-position, which adversely affects traveling.

For example, in a case where traveling road map data 310 used for position estimation by the first self-position estimation method is distorted with respect to the real environment, such a phenomenon occurs. In addition, traveling road map data 310 is often created by using so-called SLAM processing in which self-position estimation and map creation are sequentially performed using ranging sensor 120, and it is difficult to eliminate distortions between the real environment and the traveling road map data 310 for the entire traveling environment.

On the other hand, it is possible to perform the self-position estimation in the SLAM processing of creating the traveling road map and the self-position estimation by the GNSS in parallel, and it is easy to compare the self-position estimation results at each point. The comparison result can be used for correcting the attitude.

That is, correction information map data 320 is created in advance at each position (that is, each recording point) in the real space by using positional deviation information of two pieces of self-position data acquired by performing self-position estimation by ranging sensor 120 and self-position estimation by GNSS sensor 130 in parallel. Then, as described above, self-position estimation system U according to the present disclosure corrects the distortion included when position P₁ measured in the first coordinate system is coordinate-transformed into the second coordinate system by using the correction information calculated in advance at each position (that is, each recording point) in the real space.

As a result, self-position P₁ expressed in the first coordinate system estimated by first self-position estimation unit 210 can be accurately converted into the expression format of the second coordinate system. That is, this makes it possible to use two self-position estimation algorithms in a complementary manner.

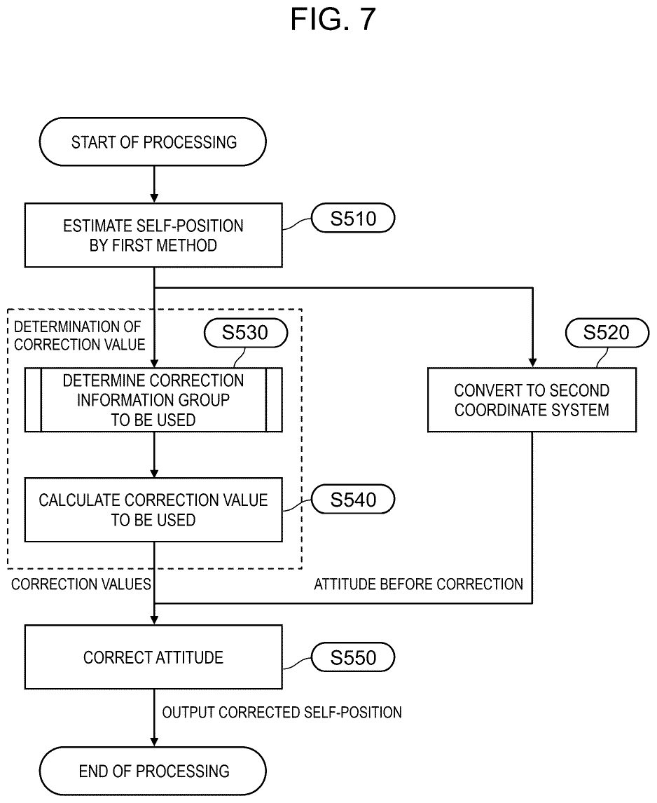

Next, processing of correcting the self-position using the correction information map will be described. FIG. 7 is a flowchart illustrating correction processing performed by self-position correction unit 240.

First, in S510, controller 15 calculates position P₁ which is the self-position estimation result by the first self-position estimation method.

Next, in S520, controller 15 converts position P₁ expressed on the first coordinate system into position P_{transed} expressed on the second coordinate system. This processing is performed using above-described coordinate system transformation vector P_{offset}.

Next, in S530, controller 15 determines correction information group ANCuse to be used for calculation of the correction value.

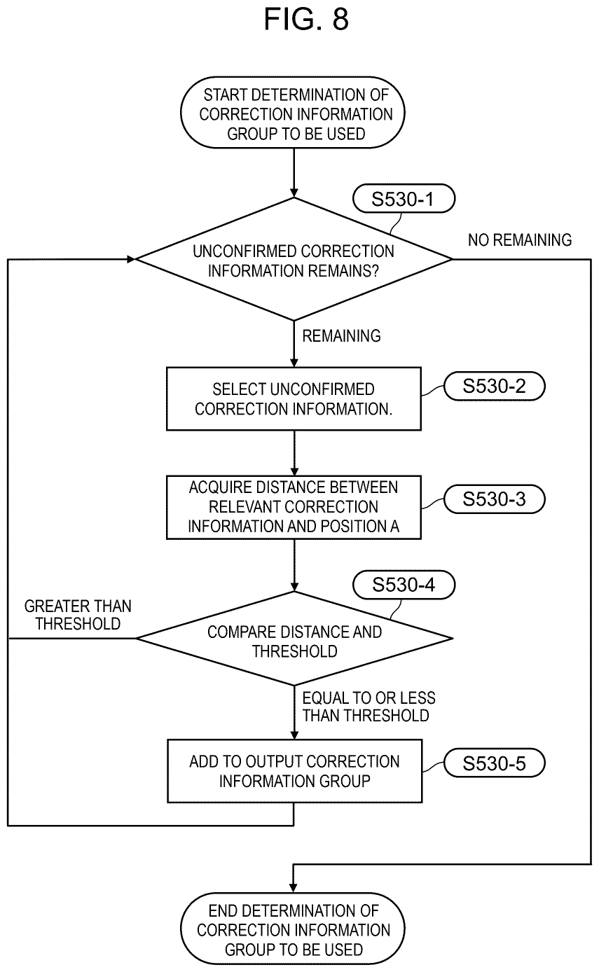

Here, processing for determining correction information group ANCuse used for calculation of the correction value will be described with reference to FIG. 8.

FIG. 8 is a flowchart of a subroutine obtained by decomposing the processing of S530 into detailed steps. FIG. 9 is a diagram schematically illustrating the processing of S530 in FIG. 7. Each dot in FIG. 9 is a recording point at which the correction information is stored in correction information map data 320.

First, in S530-1, controller 15 checks whether undetermined correction information remains in correction information map data 320. When the correction information remains, one of pieces of the undetermined correction information is selected (S530-2).

Next, in S530-3, controller 15 calculates the distance between the position of the recording point associated with the correction information selected in S530-2 and position P₁. The calculated distance value is defined as distance value A. A method of calculating distance value A is shown in the following Formula (7).

$$\begin{matrix}[ Math . 7 ] & \\ Position of recording point = ( {x}_{h} , {y}_{h} ) & ( 7 - 1 )\end{matrix}$$

$$Distance value A = \sqrt{{( {x}_{1} - {x}_{h} )}^{2} + {( {y}_{1} - {y}_{h} )}^{2}} \qquad ( 7 - 2 )$$

Next, in S530-4, controller 15 compares distance value A calculated in S530-3 with a distance threshold. When distance value A is equal to or less than the distance threshold, the process proceeds to S530-5. When distance value A is larger than the distance threshold, the processing of the correction information is ended, and the process returns to S530-1.

Next, in S530-5, controller 15 adds the correction information selected in S530-2 to correction information group ANCuse used for calculating the correction value. After the addition, the process returns to S530-1, and the determination processing regarding other correction information in correction information map data 320 (that is, processing of determining whether or not to use for calculation of correction value) is executed again.

If it is determined in S530-1 that confirmation of all the correction information in correction information map data 320 has been completed, controller 15 outputs created correction information group ANCuse and ends the processing of S530.

Next, in S540, controller 15 determines correction value Pₕₒₛₑᵢ. Correction value Pₕₒₛₑᵢ is calculated by taking a weighted average with the distance from position P₁ to the position of each recording point as a weight with respect to the correction value included in the correction information of each recording point. Specifically, the following Formula (8) is obtained.

$$\begin{matrix}[ Math . 8 ] & \\ \begin{matrix}num := Number of pieces of used correction information \\ {P}_{hosei} := ( {x}_{hosei} , {y}_{hosei} , {θ}_{hosei} ) \\ {x}_{hosei} = \frac{{Σ}_{x ∈ {ANC}_{use}} ( {x}_{anchosei} )}{num} \\ {y}_{hosei} = \frac{{Σ}_{y ∈ {ANC}_{use}} ( {y}_{anchosei} )}{num} \\ {θ}_{hosei} = \frac{{Σ}_{θ ∈ {ANC}_{use}} ( {θ}_{anchosei} )}{num}\end{matrix} & ( 8 )\end{matrix}$$

Next, in S550, controller 15 calculates self-position P_{correced} as the correction result using position P_{transed} obtained by converting position P₁ into the second coordinate system and correction value Pₕₒₛₑᵢ. Specifically, the calculation is performed by the following Formula (9).

$$\begin{matrix}[ Math . 9 ] & \\ \begin{matrix}{P}_{corrected} = ( {x}_{corrected} , {y}_{corrected} , {θ}_{corrected} ) \\ {x}_{corrected} = {x}_{transed} + {x}_{hosei} \\ {y}_{corrected} = {y}_{transed} + {y}_{hosei} \\ {θ}_{corrected} = {θ}_{transed} + {θ}_{hosei}\end{matrix} & ( 9 )\end{matrix}$$

By following the steps of S500 to S550, both the second self-position estimation method calculated on the second coordinate system and the first self-position estimation method calculated on the first coordinate system can be used as the self-position estimation results on the second coordinate system, and the two self-position estimation results can be switched and used.

Note that, since the higher the arrangement density of the recording points in correction information map data 320, the higher the accuracy of self-position estimation, it is preferable to generate correction information map data 320 in which more recording points are arranged in advance.

By using the method of the present disclosure, for example, autonomous mobile robot 10 can smoothly travel while switching the self-position estimation algorithm during autonomous movement. That is, controller 15 according to the present disclosure controls the movement of autonomous mobile robot 10 while alternately switching between a first movement control mode in which movement control of autonomous mobile robot 10 is performed using the first self-position estimated by first self-position estimation unit 210 and a second movement control mode in which movement control of autonomous mobile robot 10 is performed using the second self-position estimated by second self-position estimation unit 220. For example, controller 15 switches the self-position estimation function to be used according to the estimation accuracy of the second self-position estimation method output by second self-position estimation unit 220.

Although specific examples of the present invention are described above in detail, they are mere exemplifications and do not limit the scope of claims. The technique described in the claims includes various variations and changes of the specific examples exemplified above.

### INDUSTRIAL APPLICABILITY

The present disclosure relates to a position estimation system, and is particularly useful for a self-position estimation method of an autonomous mobile robot.

### REFERENCE MARKS IN THE DRAWINGS

U self-position estimation system
10 autonomous mobile robot
15 controller
110 wheel rotation speed sensor
120 ranging sensor
130 GNSS sensor
200 calculator
210 first self-position estimation unit
220 second self-position estimation unit
230 self-position convert unit
240 self-position correction unit
300 storage
310 traveling road map data
320 correction information map data
P1 self-position (first self-position)
P2 self-position (second self-position)

1. A self-position estimation system for a mobile body, comprising:
a first self-position estimation unit that estimates a first self-position in a first coordinate system by using a first positioning sensor mounted on the mobile body;
a second self-position estimation unit that estimates a second self-position in a second coordinate system by using a second positioning sensor mounted on the mobile body;
a self-position convert unit that converts the first self-position estimated by the first self-position estimation unit and expressed in the first coordinate system into an expression format in the second coordinate system; and
a self-position correction unit that corrects the first self-position converted into an expression format in the second coordinate system using correction information map data that stores, as correction information, a positional deviation amount of a recording point in a real space expressed in the first coordinate system with respect to the second coordinate system.

2. The self-position estimation system according to claim 1, wherein
the self-position correction unit
extracts, from the correction information map data, the correction information stored in association with the recording point whose distance from the first self-position is equal to or less than a predetermined distance, and
corrects the first self-position based on the extracted correction information.

3. The self-position estimation system according to claim 2, wherein in a case where there are a plurality of the recording points, the self-position correction unit calculates a correction value to be applied to the first self-position by weight-averaging the correction information stored in association with the plurality of recording points based on a distance between the first self-position and each position of the plurality of recording points.

4. The self-position estimation system according to claim 1, wherein each of the first self-position and the second self-position includes a coordinate position and a direction of the mobile body.

5. The self-position estimation system according to claim 1, wherein
the first self-position estimation unit estimates the first self-position by a position estimation method using a ranging sensor, and
the second self-position estimation unit estimates the second self-position by a position estimation method using a satellite positioning system.

6. The self-position estimation system according to claim 1, wherein the mobile body is an autonomous mobile robot.

7. The self-position estimation system according to claim 1, further comprising a controller that performs movement control of the mobile body while switching between a first movement control mode in which movement control of the mobile body is performed using the first self-position estimated by the first self-position estimation unit and a second movement control mode in which movement control of the mobile body is performed using the second self-position estimated by the second self-position estimation unit.

8. A self-position estimation method for a mobile body, comprising:
estimating a first self-position in a first coordinate system by using a first positioning sensor mounted on the mobile body;
estimating a second self-position in a second coordinate system by using a second positioning sensor mounted on the mobile body;
converting the first self-position expressed in the first coordinate system into an expression format in the second coordinate system; and
correcting the first self-position converted into an expression format in the second coordinate system using correction information map data that stores, as correction information, a positional deviation amount of a recording point in a real space expressed in the first coordinate system with respect to the second coordinate system.
